(19) United States
(12) Patent Application Publication
(10) Pub. No.: US 2013/0311917 A1
(43) Pub. Date: Nov. 21, 2013

(54) ADAPTIVE INTERACTIVE MEDIA SERVER AND BEHAVIOR CHANGE ENGINE

(71) Applicants: Gal Bar-or, Wilson, WY (US); Eric Zimmerman, San Anselmo, CA (US)

(72) Inventors: Gal Bar-or, Wilson, WY (US); Eric Zimmerman, San Anselmo, CA (US)

(21) Appl. No.: 13/475,339

(22) Filed: May 18, 2012

(51) Int. Cl. G06F 3/048

(52) U.S. Cl. 715/764

(57) ABSTRACT

Presenting content to users in an interactive content presentation system. The content presented is dynamically selected at the time of presentation, in response to information available about those users at the time of presentation. Dynamic selection is in response to substantially all information available about those users at the time. Dynamic selection can include choices of particular content, the method or modality of presentation, the information included, as determined by rules for dynamic selection provided by an author. A method in which content is presented to users to encourage those users to modify their health-related behavior, such as related to improvement of dietary considerations, activity and exercise considerations, sleep considerations, and stress management considerations. In another example, the method includes a method in which content is presented to users to encourage those users to make other and further improvements, such as teaching users to manage their retirement accounts.

This application is filed in the name of inventors Gal Bar-or and Eric Zimmerman, assignees to RedBrick Health Corporation.

### CROSS-REFERENCES TO RELATED APPLICATIONS

Inventions described in this application may be used in combination or conjunction with one or more concepts and technologies disclosed in the following documents:
U.S. patent application Ser. No. 12/571,898, filed Oct. 1, 2009, titled “System And Method For Incentive-Based, Consumer-Owned Healthcare Services”, attorney docket number P190798.US.02;
U.S. patent application Ser. No. 12/713,013, filed Feb. 25, 2010, titled “System and Method for Incentive-Based Health Improvement Programs and Services”, attorney docket number P190798.US.04;
U.S. patent application Ser. No. 12/889,803, filed Sep. 24, 2010, titled “Personalized Health Incentives”, attorney docket number P191617.US.02;
U.S. patent application Ser. No. 12/945,086, filed Nov. 12, 2010, titled “Interactive Health Assessment”, attorney docket number P191542.US.02;
U.S. Provisional Patent Application Ser. No. 61/101,885, filed Oct. 1, 2008, titled “System and Method for Consumer-Owned Health Care Services”, attorney docket number P190798.US.01;
U.S. Provisional Patent Application Ser. No. 61/101,888, filed Oct. 1, 2008, titled “System And Method For Health Care Based Incentives”, attorney docket number P190799.US.01;
U.S. Provisional Patent Application Ser. No. 61/101,889, filed Oct. 1, 2008, titled “Personal Health Map”, attorney docket number P190800.US.01;
U.S. Provisional Patent Application Ser. No. 61/245,819, filed Sep. 25, 2009, title, “Personalized Healthcare Incentives”, attorney docket number P191617.US.01;
U.S. Provisional Patent Application Ser. No. 61/260,728, filed Nov. 12, 2009, title, “Interactive Health Assessment”, attorney docket number P191542.US.01; and
U.S. Provisional Patent Application Ser. No. 61/544,901, filed Oct. 7, 2011, titled “Social Engagement Engine for Health Wellness Program”, attorney docket number P221449.US.01.

This application claims priority to each of these documents. Each of these documents, and all documents cited in each of these documents, are hereby incorporated by reference herein in their entirety as if fully set forth herein.

### BACKGROUND

1. Field of the Disclosure

This application generally relates to techniques, including computer-implemented methods and computing systems, which can present content to users in response to choices made by those users and in response to information about those users. In one embodiment, these techniques can be used to conduct a computer-implemented journey through content which is intended to encourage users to improve their health-related behavior, as further described herein. In other embodiments, these techniques can be used to conduct a computer-implemented journey through content which is intended to educate users with respect to how to invest their 401(k) funds. In still other embodiments, these techniques can be used to conduct a computer-implemented journey through content which is intended to encourage users, educate users, or otherwise assist users in successfully changing behaviors and maintaining new behaviors, with respect to other subjects or topics.

2. Background of the Disclosure

Computerized behavior modification and learning systems present information to users with the intent of encouraging those users to learn information and skills, and with the intent of encouraging those users to modify their behavior. One problem in the known art is that these computerized systems are substantially rigid in the way they present information, both in terms of the type of information they present, the order in which they present that information, and the speed with which they attempt to present that information to the user. Users can benefit when the information presented to them is unique to their particular circumstances, when the information presented to them is presented in an order which is responsive to their capacity to understand that information, and when the information presented to them is responsive to their motivation to act upon that information. In particular, when information presented to users is intended to encourage those users to make behavior changes, users are more likely to make behavior changes when that information is presented to them in response to their particular circumstances, their capacity to understand that information, and their motivation to act upon that information.

In a healthcare context, there are substantial benefits which can be achieved, for users, for employees, for employers, for insurers, and for the community at large, for users to improve their behavior and behavioral patterns related to their health, such as related to improvement of dietary considerations, activity and exercise considerations, sleep considerations, and stress management considerations. In other contexts, there are substantial benefits which can be achieved, for users, for employees, for employers, and for the community at large, for users to improve their behavior and behavioral patterns related to other behaviors. These include, for example: (A) managing their on-the-job safety skills, such as relating to repetitive stress injuries and other workplace injuries (B) managing their retirement funds, such as in a 401(k), IRA, or other retirement account, and (C) other skills which are important for users, for which users evince any significant interest therein.

### BRIEF SUMMARY OF THE DISCLOSURE

This application provides techniques for assembling and presenting content to users in an interactive content presentation system, in which the content that is assembled and presented to users is dynamically selected at the time of presentation, in response to information available about those users at the time of presentation, as well as in response to statistical information about behavior by users who are similarly situated or whose response to that content can be predicted with reasonable likelihood.
Content can be assembled and presented to users using one or more of an set of available devices, and using one or more of a set of available media.
Dynamic assembly and selection of content can be in response to substantially all information available about those users and the users' environment at the time of presentation, as well as in response to information about other users (such as statistical information, as noted above).
Dynamic assembly and selection of content can include a choice of the particular content, a choice of the method or modality of presentation for that content, a choice of the information included in that content, and otherwise, as determined by rules for dynamic selection provided by an author.
Dynamic assembly and selection of content can be responsive to information about other users, such as information which is tracked over time as other users engage in journeys, such as statistical information about users who are similarly situated, such as information allowing users' response to content can be predicted with reasonable likelihood, or otherwise.
Dynamic assembly and selection of content can be responsive to a set of rules. Those rules can be initially determined by an author, and they can be modified by information about other users (including other users' ratings of that content, use of that content, and results of using that content), with the effect of a system using these techniques having the property of adapting or learning in response to that information, and conducting emergent activity in response thereto.

In one embodiment, techniques include a computing system including a processor, a data storage medium, and software, wherein the software may cause the computing system to perform methods and techniques described herein. In one embodiment, techniques include computer-implemented methods according to the system and techniques described herein. In one embodiment, a computer readable medium, which may include computer-executable instructions configured to cause a computer to perform methods and techniques described herein.
In a first example, techniques include methods in which content is assembled and presented to users to encourage those users to modify their health-related behavior, such as related to improvement of nutrition, activity and exercise, sleep, stress and resiliency management, cessation of negative behaviors (such as use of tobacco, excessive use of alcohol, and otherwise), self care of other health considerations (such as back strain or back pain, diabetes or pre-diabetic condition management, and otherwise), and training for athletic events. This has the effect that those users are prompted to change their health-related behavior, so as to optimize their health and any health-related measures of function.
In a second example, techniques include methods in which (A) content is assembled and presented to users to help those users to optimize employee benefit selections, (B) content is assembled and presented to users to help those users to construct and manage their 401(k) or other retirement accounts. This has the effect that those users are prompted to change their benefit-management behavior, so as to optimize their benefits and any related measures of function.
In other examples, techniques include methods in which content is assembled and presented to users to attain new knowledge or skills, to change or optimize their behavior with respect to other life-enhancing factors, or otherwise. This has the effect that those users are prompted to improve or modify their behavior, so as to optimize any related measures of function.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 shows a conceptual drawing of an example journey authoring and presentation system.

FIG. 2 shows a conceptual drawing of an example journey.

FIG. 3 shows a conceptual drawing of example Act objects, showing example Stage objects, example Scene objects, and example components.

FIG. 4 shows a conceptual drawing of an example Act, Stage, or Scene object.

FIG. 5 shows a conceptual drawing of an example presentation of a set of Scene objects.

FIG. 6 shows a conceptual drawing of an example method of selecting and presenting Scene objects.

### DETAILED DESCRIPTION

### Definitions and Notation

This application should be read in view of the following terms. In each case, an exemplary description is given. However, the definitions recited for these terms are inclusive and are not intended to be limiting in any way.
The text “Ractive” (and variants thereof) generally refers to an authored template for an interactive experience to be performed by a user. A Ractive is composed by an author and includes a set of content and a set of rules for assembly and presentation of that content to users. While a Ractive represents a generic version of a Journey to be conducted by users, each individual user interacts separately with the Ractive, with the effect of engaging in their own substantially unique specific instance of the Journey, and possibly altering the content and rules associated with the Ractive during their specific instance of the Journey. In one embodiment, each Ractive designates a set of Scene objects, each of which can be personalized to individual users for their particular Journeys. In one embodiment, the Scene objects are assembled and presented to the user in a sequence and fashion (and in a dynamically selected medium or modality) specific to that user, in response to information about that particular user and in response to a collective experience of assembling and presenting content to users.
The text “Scene”, “Scene object” (and variants thereof) generally refers to an individual set of content which is assembled and presented to a user, and to which the user can provide feedback. In on embodiment, each Scene forms part of the substantially unique Journey conducted by the user.
The text “Component” (and variants thereof) generally refers to an individual content element, or user interface element, to be assembled with a Scene and presented to a user with that Scene.
The text “Journey” (and variants thereof) generally refers to a user's individually experienced sequence of Scenes, including assembled and presented content, and feedback from the user. In one embodiment, each Journey is an example of a substantially unique pathway in response to a Ractive. In one embodiment, each Journey is responsive to a Ractive, but includes a substantially unique instance of that Ractive as performed by an individual user, and is intended to help that user to master and maintain a behavior change through the selection and completion of a series of steps, each of which is assembled and presented as part of a Scene.
The text “Composer” (and variants thereof) generally refers to an element of a computer system used by an author to create or specify a Ractive, including that Ractive's content, rules, and other attributes.
The text “Conductor” (and variants thereof) generally refers to an element of a computer system responsive to the Ractive and to information about the user and about other users' experiences, to determine which Scenes to assemble and present to the user as part of that user's Journey.
The text “Performer” (and variants thereof) generally refers to an element of a computer system that presents Scenes to the user, on a target device or medium, and receives feedback from the user in response thereto.

After reading this application, those skilled in the art will recognize other and further concepts included within the meanings for these terms, which are within the scope and spirit of the invention, and which would be workable without any further invention or undue experiment.

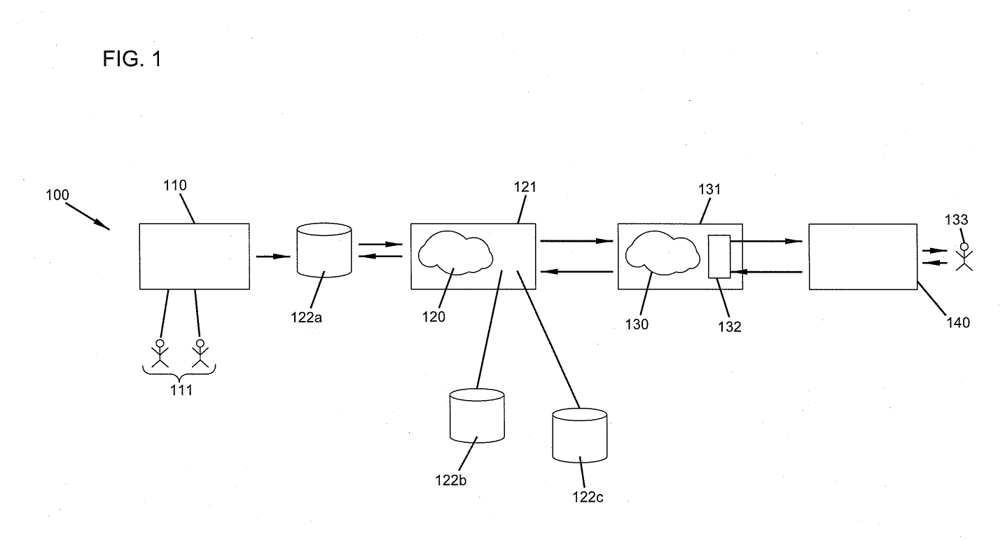

FIG. 1

FIG. 1 shows a conceptual drawing of an example journey authoring and presentation system.

A journey presentation system 100 includes a composer tool 110, operated by one or more authors 111, a conductor 120, executed on one or more computing devices 121 and using one or more data structures 122, and a performer 130, executed on one or more (possibly distinct) computing devices 131 and including one or more user interfaces 132, to interact with one or more users 133. In one embodiment, the performer 130 can present the one or more user interfaces 132 in distinct forms on different physical user interface devices 140.

The authors 111 use the composer tool 110 to create a Ractive, as further described below. A Ractive represents a generic set of possible Journeys, and is included in the one or more data structures 122 used by the conductor 120. While the Ractive is itself one particular data structure, the Ractive describes a generic set of possible Journeys and represents a very large number of distinct possible Journeys, and the actual use of that Ractive provides the user 133 with an individual instance of the Journey. Each Journey which is actually performed is individually determined in response to a corresponding particular user 133, with the nature of the particular instance depending the upon user 133 who is engaged with the Ractive. This has the effect that each particular user 133 is associated with their own individual and substantially unique instance of the Journey.

The Ractive is used by the conductor 120 and the performer 130 to present an instance of a Journey when interacting with a particular user 133. The Ractive includes information with respect to a set of content to present to the user 133, as well as information with respect to dynamic selection of that content. Dynamic selection of that content, as described in the Ractive, and as further described herein, can include particular information to include in that content, methods or modalities for presenting that content, and choices and options to present to the user 133 as part of that content, as further described herein. For example the individual instance of the Journey can be responsive to those choices or selections by the user 133, that feedback from the user 133, and that other information received about the user 133.

Choices and selections made by the user 133 can include selections by the user 133 from a set of possible activities, answers by the user 153 to questions assembled and presented by the performer 130, or otherwise.
For one example, the conductor 120 can cause the director 130 to present the user 133 with a selection of choices for possible activities the user 133 can do, or commitments the user 133 can make, as next steps in that user's Journey. In a health context, these might include asking the user 133 for a preference regarding whether to improve their amount or choice of dietary intake, improve their activity or exercise level, improve their sleep regimen, manage or reduce their stress level, or otherwise.
For another example, the conductor 120 can cause the performer 130 to present the user 133 with a set of questions with respect to that user's lifestyle. In a health context, such questions might include the nature of the user's diet, the nature of the user's activities and exercise, and otherwise.
In such examples, the user's choices for possible activities to conduct or commitments to make, or the user's expressed preferences, or a determination in response to the user's answers to questions, can be used to determine a direction for the user's particular Journey to continue. In one such case, in a health context, if the user 133 chooses to improve their activities, or the user's answers to questions indicate the user's lifestyle is excessively sedentary, the Journey can continue with a set of content intended to encourage the user 133 to adopt a more active and less sedentary lifestyle. Such a Journey might have many relatively small steps, each intended to encourage the user 133 to move a little bit further along the Journey from a more sedentary to a more active lifestyle.

Feedback from the user 133 can include information received from the user 133, such as with respect to actions taken by the user when not using the system 100.
For one example, in a health context, if the user 133 has committed to exercise three times in a given week, the conductor 120 can cause the performer 130 to ask the user 133 each day whether the user 133 actually did exercise that day, collecting that information to determine whether the user 133 met their commitment.
For another example, in a health context, if the user 133 has committed to not eat dinner while watching TV, the conductor 120 can cause the performer 130 to ask the user 133 each day whether the user 133 really did or did not eat dinner while watching TV that day, collecting that information to determine whether the user 133 met their commitment.
In such examples, the conductor 120 can use the information received from the user 133 to determine which content is most important, and therefore highest priority, to present to the user 133. As described below, the conductor 120 causes the performer 130 to present, to the user 133, content which the conductor 120 considers best.

Other information received about the user 133 can include information received about the user 133 from other sources.
For one example, in a health context, the user 133 might use a weight scale which is coupled to the system 100 and which independently provides a weight value for the user 133 independently of what the user 133 reports.
For another example, in a health context, the system 100 might receive independent information about the user's health from an external source, such as a medical record or an insurance record relating to the user 133.

In one embodiment, operation of the system 100 using the Ractive includes several principles of behavior modification:
What the system 100 knows about the user 133 is any one context is also available in all other contexts.
Content assembled and presented to the user 133 is updated so as to be as recent as possible, and is responsive to all information from the user 133, and all interactions, which have preceded the current interaction with the user 133, independent of what method was used to interact with the user 133.
The user 133 has the choice and opportunity to interact with the system 100 using the user's choice of one or more modalities.
The user's choice of direction determines in which direction the Journey proceeds.
Content assembled and presented to the user 133 is intended to engage the user's interest and encourage the user to interact and to commit to activities and behavior.

An author 111 can include one or more persons who construct the Ractive, or might include one or more computation tools which assist those persons in constructing the Ractive. As described herein, the author 111 constructs the Ractive, including the content to be included in the Ractive, the decision points to be included in the Ractive, the rules for selecting what content to present or what method or modality for presenting that content, and other information as described herein. However, as described above, the author 111 does not necessarily determine the individual instance of the Journey traveled by the user 133, as the individual instance of the Journey traveled by the user 133 is responsive both to the Ractive and to the particular user 133.

As further described herein, the conductor 120 reviews the Ractive and information with respect to the user 133, and dynamically selects content to present to the user 133. As the Journey proceeds, the conductor 120 maintains information about the particular Journey, including possibly modifying the Ractive to include choices and selections made by the user 133, information received directly from the user 133, and information received about the user 133 from other sources.

In one embodiment, the conductor 120 includes a machine learning element, disposed to receive the information described above (choices and selections made by the user 133, feedback from the user 133, and other information received about the user 133) and disposed to model one or more of the user's interaction preferences, learning abilities and style, motivation level and likely motivators, and any other information about the user 133 which the conductor 120 could find useful in determining content to present to the user 133.

While this application generally describes the conductor 120 as being executed as if on a single computing device 121, in the context of the invention, there is no particular requirement for any such limitation. For example, the one or more computing devices 121 can include a cluster of devices, not necessarily all similar, on which the conductor 120 is executed, such as a cloud computing execution platform. Similarly, while this application generally describes the performer 130 as being executed as if on a single computing device 131, in the context of the invention, there is no particular requirement for any such limitation. For example the one or more computing devices 131 can include a cluster of devices, not necessarily all similar, on which the performer 130 is executed, such as a cloud computing execution platform. Also, while this application generally describes the one or more computing devices 121 and the one or more computing devices 131 as distinct, in the context of the invention, there is no particular requirement for any such limitation. For example the one or more computing devices 121 and the one or more computing devices 131 could include common elements, or might even be substantially the same device, executing the conductor 120 and the performer 130 as separate processes or threads.

As further described herein, the performer 130 receives the determination of which content to present to the user 133 from the conductor 120, and interacts with the user 133. Interacting with the user 133 includes presenting the content to the user 133 and receiving any associated responses from the user 133. Those associated responses from the user 133 can include both data elements (such as choices by the user 133 and answers to questions assembled and presented to the user 133), as well as information with respect to timing of those choices or answers, or modality by which the user 133 presented those choices or answers.

A user 133 can include one or more users who engage in the instance of the Journey, such as an individual attempting to engage in behavior change, or a team. A user 133 can include a team of individuals, a corporate entity, or another type of collective group or team, who collectively or individually interact with the system 100, concurrently or separately.

Although examples are primarily described herein with respect to a user 133 who is an individual, in the context of the invention, there is no particular requirement for any such limitation. In one example, when a team including several individuals interacts with the system 100, the conductor 120 maintains information about the particular Journey for that team, maintaining that information for that team's instance of the Ractive, and the conductor 120 causes one or more instances of the performer 130 to present content and collect information from those individuals who make up the team.

The physical user interface devices 140 could include anything capable of interacting with the user 133, such as by presenting content to the user 133 and by receiving responses from the user 133. For example, the physical user interface devices 140 could include a desktop or laptop computer with a monitor, keyboard and pointing device; a netbook, tablet or touchpad computer with a monitor and touchscreen; a mobile phone or media presentation device such as an iPhone™ or iPad™, or other devices.

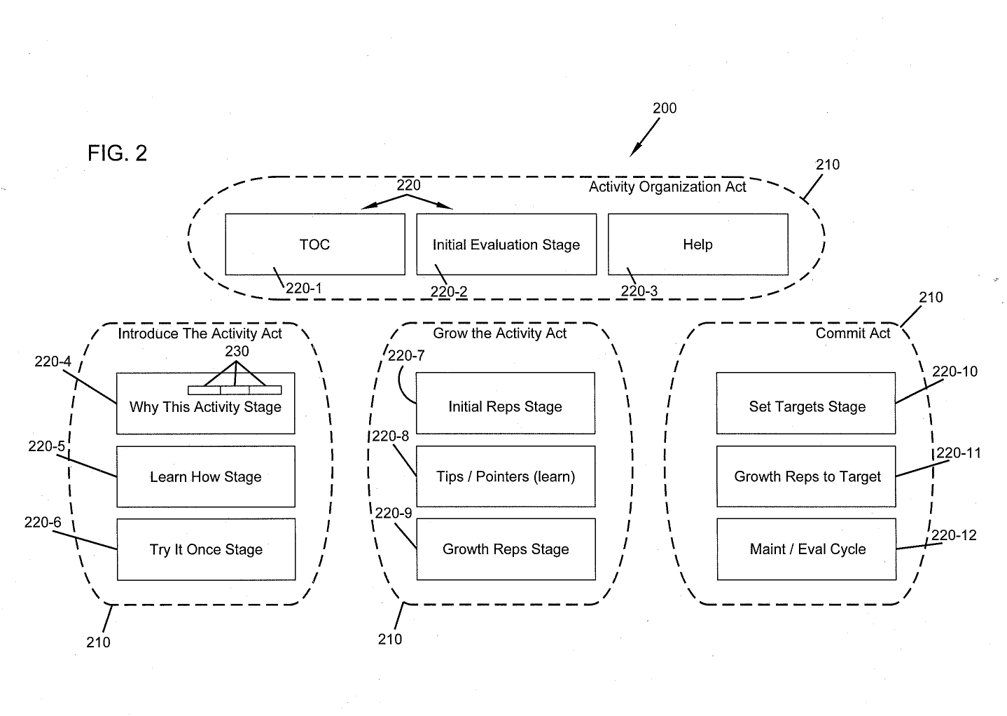

FIG. 2

FIG. 2 shows a conceptual drawing of an example Journey.

As described herein, a Journey 200 includes one or more Act objects 210, each of which includes one or more Stage objects 220, each of which includes one or more Scene objects 230. The particular Journey 200 described below is only one example of a very large number of possible Journeys 200 which might be particularized to the user 133.

In one example, the Journey 200 might begin with an initial organization segment, in which the conductor 120 causes the performer 130 to present content intended for the user 133 to decide what types of behavior that user 133 is going to engage in. In one example, in a health context, the user 133 might be asked whether they wish to work on their diet and food choices, on their activity and exercise habits, on their sleep habits, on stress management, or on some other topic. Once the user 133 has selected what types of behavior to engage in, the conductor 120 causes the performer 130 to present content intended for the user 133 to provide information so that the system can evaluate the user's relative advancement in that type of behavior. In one example, in a health context, the user 133 might be asked to provide a set of evaluations regarding whether they cook at home, whether they eat so-called “fast food”, what proportion of their diet includes meats or vegetables, and the like.

Once the user 133 has provided that information, the conductor 120 causes the performer 130 to present content intended for the user to repeatedly pick individual steps toward improved behavior. In one example, in a health context, the conductor 120 selects three to five possible Scene objects 230 for next presentation, and causes the performer 130 to describe those Scene objects 230 and ask the user 133 for a choice with respect to which Scene object 230 with which to follow up, and following up with the user's choice of Scene object 230. Thereafter, the performer 130 obtains information, such as from the user 133 or external sources, the conductor 120 re-evaluates the priority of each Scene object 230, and the conductor 230 repeats the process of selecting three to five possible Scene objects 230 for next presentation, causing the performer 130 to describe those Scene objects 230 and ask the user 133 for a choice with respect to which Scene object 230 with which to follow up, and following up with the user's choice of Scene object 230.

In one example, the Journey 200 might begin with an “Activity Organization” Act object 210, in which the user 133 conducts an activity intended to organize the Journey 200, such as in which the user 133 is introduced to the Journey 200. In this example, the “Activity Organization” Act object 210 includes a set of Stage objects 220, including a “Table of Contents” Stage object 220-1, in which the user 133 is provided an explanation of reasons for the Journey 200, an “Initial Evaluation” Stage object 220-2, in which the user 133 is provided with self-evaluation feedback content from which an initial evaluation can be performed, and a “User Help” Stage object 220-3, in which the user 133 is provided with further information about the Journey 200.
For a 1^{st} example, the Journey 200 might include elements to provide the user 133 with behavioral tools to improve their health. For a 2^{nd} example, the Journey 200 might include elements to provide the user 133 with informational tools to manage their finances. In other examples, the Journey 200 might include other and further elements of value to the user 133.
In a health context, such as an example in which the Journey 200 includes elements to provide the user 133 with behavioral tools to improve their health, the “Initial Evaluation” Stage 220-2 can include content intended to solicit information about the user's current diet, physical activity, stress management, and sleeping patterns. As this information is received, the conductor 120 modifies information relating to the user 133 in that user's particular instance of the Ractive, with the effect that that Journey 200 is personalized to the particular user 133.
In a health context, the user 133 can be presented in the “Initial Evaluation” Stage 220-2 with an opportunity to select one or more of a set of health-related behaviors on which to work. For example, the user could be asked if they prefer to address behaviors relating to diet, or behaviors relating to activity and exercise. As further described herein, the conductor 120 modifies information in response to the user's expressed preference.

In one example, the Journey 200 includes a set of Act objects 210, including an “Introduce the Activity” Act object 210, in which the user 133 might be introduced to the advantages of the beneficial behavior being taught, a “Grow the Activity” Act object 210, in which the user 133 might be familiarized with the techniques and procedures of the beneficial behavior being taught, and a “Commit” Act object 210, in which the user 133 might be shown how to integrate those techniques and procedures, and urged to carry out those procedures on a regular basis. This example shows these Act objects 210 and their Stage objects 220 as being performed in a pre-selected sequence. However, in the context of the invention, there is no particular requirement for any such requirement. For example, these Act objects 210 can be performed in different sequences in response to activities and responses by the user 133, as further described herein.
In this example, the “Introduce the Activity” Act object 210 includes a set of Stage objects 220, including a “Why This Activity” Stage object 220-4, in which the user 133 is provided with an explanation of why the activity is beneficial, a “Learn How” Stage object 220-5, in which the user 133 is provided with a description of how to perform the particular activity, and a “Try It Once” Stage object 220-6, in which the user 133 is provided with an opportunity to attempt the particular activity.
In this example, the “Grow the Activity” Act object 210 includes a set of Stage objects 220, including a “Initial Repetitions” Stage object 220-7, in which the user 133 is provided with an opportunity to perform some examples of the activity, a “Tips/Pointers” Stage object 220-8, in which the user 133 is provided with further information about how to perform the particular activity, and a “Growth Repetitions” Stage object 220-9, in which the user 133 is provided with an opportunity to increase their performance of the activity.
In this example, the “Commit” Act object 210 includes a set of Stage objects 220, including a “Set Targets” Stage object 220-10, in which the user 133 is provided with an opportunity to set goals for further performing the activity, a “Growth To Targets” Stage object 220-11, in which the user 133 is provided with an opportunity to increase their perfoimance of the activity to those goals, and a “Maintenance and Evaluation” Stage object 220-12, in which the user 133 is provided with an opportunity to maintain and evaluate their performance of the activity.

In this example, the Act objects 210 and the Stage objects 220 are performed in a pre-selected sequence. However, in the context of the invention, there is no particular requirement for any such requirement. For example, these Stage objects 220 can be performed in different sequences in response to activities and responses by the user 133, as further described herein.

As further described herein, the Stage objects 230 (described below) are assembled and presented in an order which is not necessarily predetermined by the author 111. Rather, the order in which the Stage objects 230 are assembled and presented is responsive to the user's choices and selections, information collected from the user 133 (sometimes herein called “collected” information), and information received about the user 133 (sometimes herein called “derived” information). As the user 133 makes choices and selections, as the user 133 provides information, and as information is provided about the user 133, the conductor 120 dynamically chooses Scene objects 230 for presentation to the user 133, and causes the performer 130 to present the content associated with those Scene objects 230 to the user 133.

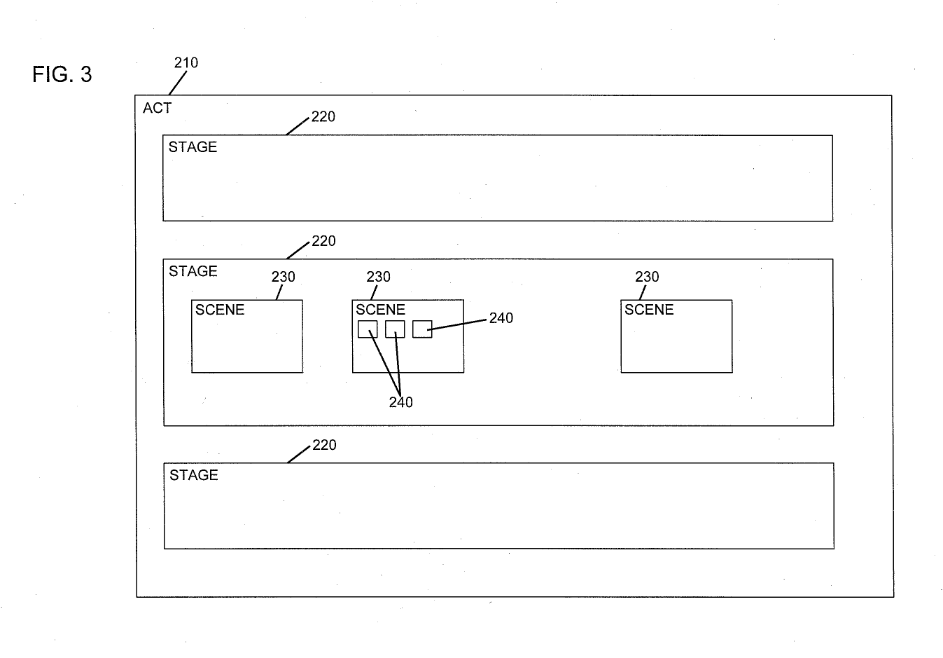

FIG. 3

FIG. 3 shows a conceptual drawing of example Act objects, showing example Stage objects, example Scene objects, and example components.

Each Act object 210 includes a set of Stage objects 220. In one example, each Act object 210 can represent a major portion of the user's particular Journey 200. Similarly, in one example, each Stage object 220 can represent a stage of advancement for the user's particular Journey 200, such as in the example Journey 200 above, in which the “Grow the Activity” Act object 210 included an “Initial Repetitions” Stage object 220-7, a “Tips/Pointers” Stage object 220-8, and a “Growth Repetitions” Stage object 220-9. As described above, while this example Journey 200 showed a sequence of Act objects 210 that was substantially predetermined, in the context of the invention, there is no particular requirement for any such limitation. For example, if the user's degree of commitment slips, the user 133 could be returned to an earlier Act object 210 to repeat that content until the user 133 is back to a desired degree of commitment.

Each Stage object 220 includes a set of Scene objects 230. In one example, each Scene object 230 can represent an individual evaluation of the user's behavior, an individual informational lesson to improve the user's knowledge, an individual opportunity for the user's choice of activities, an individual opportunity for feedback from the user 133, or otherwise.

Each Scene object 230 includes a set of components 240, such as individual content elements. In one example, those components 240 can include content for presentation to the user 133, such as text, pictures (such as graphics, still pictures, animation, video, or otherwise), sound, and other modalities for presentation to the user 133. Similarly, those components 240 can include opportunities for input from the user 133, such as choices (radio buttons, pull-down lists, sliders, or otherwise), voice input, and other modalities.

Although this application is primarily directed to audio-visual presentation and receipt of information, in the context of the invention, there is no particular requirement for any such limitation. For example, other modalities can include (such as for mobile devices) vibration, motion sensors, GPS or other location tracking, haptic interfaces, or otherwise.

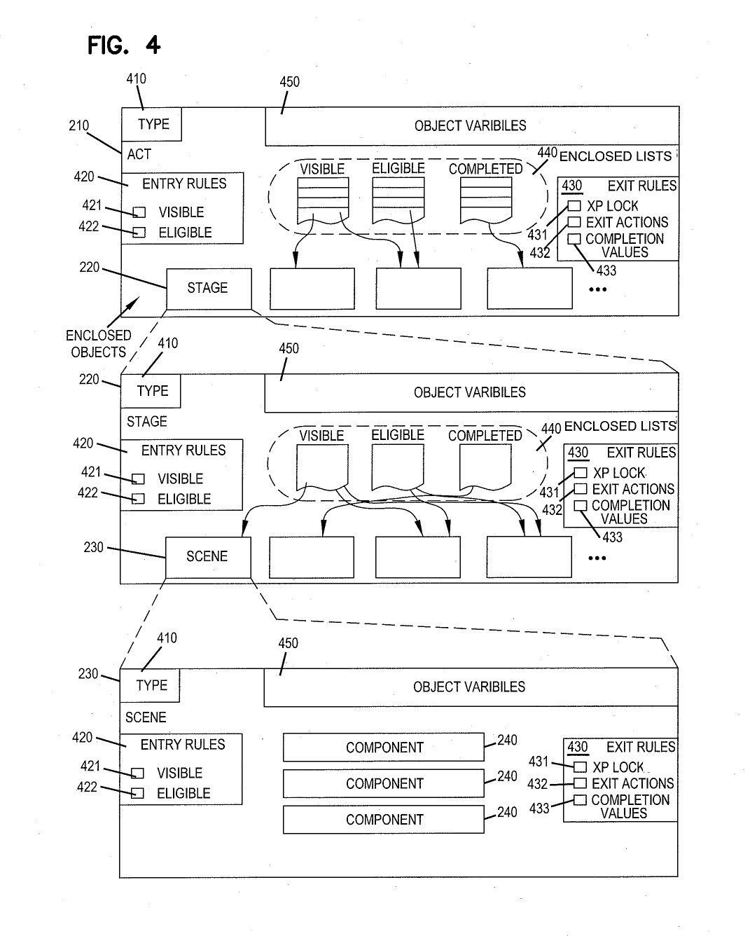

FIG. 4

FIG. 4 shows a conceptual drawing of an example Act, Stage, or Scene object.

Each Act object 210, Stage object 220, and Scene object 230, includes a type value 410, a set of entry rules 420, a set of exit rules 430, an set of enclosed object lists 440, and a set of object variables 450. Act objects 210 have Stage objects 220 as their enclosed objects, Stage objects 220 have Scene objects 230 as their enclosed objects, and Scene objects 230 have components as their enclosed objects. This has the effect that Acts are assembled and presented as a set of Stages, Stages are assembled and presented as a set of Scenes, and Scenes are assembled and presented to include a set of components.

Although objects are described as “enclosed”, in the context of the invention, there is no particular requirement that a particular object is included in only one other object. For example, a Stage object 220 need not be enclosed by only a single Act object 210, but may be accessible to more than one such Act object 210. In such cases, that particular Stage object 220 could have a pointer referencing it from more than one Act object 210, or some other implementation which achieves the same or a similar result.

In one embodiment, the type value 410, entry rules 420, exit rules 430, and enclosed objects 440 are set by the author 111, in the Ractive, as part of the Act object 210, Stage object 220, or Scene object 230. The object variables 450 are defined by the author 111, in the Ractive, as part of the object, but values for particular ones of those object variables 450 might be set or adjusted when the Ractive is executed, as part of the user's particular Journey 200.

Similarly, the particular components for each Scene object 230 are defined by the author 111, in the Ractive, as part of the Scene object 230. However, some components can be late-binded, as determined by the author 111 in the Ractive. Late-binded components can include content which is determined when the Ractive is executed.
In a 1^{st} example, late-binded information can be included in the content for the Scene object 230, such as in a message such as “Your BMI is . . . ”, where text representing the user's BMI is inserted into the blank space.
In a 2^{nd} example, late-binded information can be used to determine what content, or what attributes for content, should be included in a presentation for the Scene object 230, such as (A) showing a color GREEN when the user's BMI is less than 20, a color YELLOW when the user's BMI is between 20 and 30, and showing a color RED where the user's BMI exceeds 30, or (B) optionally showing an warning message such as “You should really cut down on the cookies,” when the user's BMI exceeds 40.

Any Scene object 230 can include one or more of these examples, or some combination or conjunction thereof.

The type value 410 includes descriptions of what type the object represents. For example, a Scene object 230 can represent an evaluation scene, a preference scene, a content scene, a picker scene, or otherwise.
In one embodiment, an evaluation scene includes a set of questions which are intended to obtain an overview of the user 133. The evaluation scene generally presents content to the user 133, and receives input from the user 133, relating to the nature of the user 133, and is intended to guide the direction of the Journey 200. The evaluation scene can interact with the user 133 to present other and further content, and receive other and further input, in response to certain information about the user's nature. In a health context, for example, if the user is relatively well-informed about amount and choice of dietary input, the Journey 200 might continue with other factors about which the user 133 is less well-informed.
In one embodiment, a preference scene includes presentation of content to the user 133, and reception of input from the user 133, in which the user 133 expresses a preference for a direction in which to take the Journey 200. The preference scene can interact with the user 133 to present other and further preferences and sub-preferences in response to certain choices made by the user 133.
In one embodiment, a content scene includes presentation of content to the user 133, and optionally reception of input from the user 133, in which the user 133 is shown information intended to educate, encourage or motivate the user 133 with respect to a particular aspect of the Journey 200. For example, in a health context, a content scene could show the user 133 how to measure food portions at a restaurant, and quiz the user 133 with respect to the information the user 133 should glean from that content.
In one embodiment, a picker scene includes presentation of content to the user 133, and reception of input from the user 133, with respect to a next Scene object 230 for presentation to the user 133. The user 133 could be presented with a choice of a number of next content scenes. The conductor 120 causes the performer 130 to present descriptions of possible next Scene objects 230 in response to those possible next Scene objects 230 which have the highest priority for presentation to the user 133. For example, in a health context, when the user 133 is being educated and encouraged about starting an activity (such as swimming), the conductor 120 could cause the performer 130 to choose a set of three (if three is the number of options designated in the Ractive) possible swimming activities (such as diving, swimming laps, or free play).

In one embodiment, the entry rules 420 include a set of visibility rules 421 and a set of eligibility rules 422
The visibility rules 421 include descriptions of when the Act object 210, Stage object 220, or Scene object 230 (sometimes herein referred to as the “object”) is allowed to be visible to the user 133. When an object is not allowed to be visible to the user 133, the conductor 120 causes the performer 130 not to show a description of that object (such as its title, or a short paragraph describing its content) in any lists of objects which are shown to the user 133. In one example, the object can be excluded from a picker Scene object 230, as described herein. In one example, in a health context (and in other contexts), a visibility rule 421 can declare that the object is never visible to male users 133, because the object relates to a topic of interest only to female users 133.
In contrast, when an object is allowed to be visible to the user 133, the conductor 120 causes the performer 130 to show a description of that object in at least some lists of objects which are shown to the user 133. In one example, in a health context, a visibility rule 421 can declare that the object is visible to users 133 whenever those users 133 have a BMI less than 20, such as, asking the user 133 whether they have ever been told by medical personnel that they are too thin for good health.
The concept of visibility is applicable, and the visibility rules 421 are applicable, regardless of modality. For example, if the performer 130 is presenting information to the user 133 using sound (such as in a text-to-speech context), an object which is not allowed to be visible is also not allowed to be audible.
In one embodiment, the descriptions for the visibility rules 421 include instructions to the conductor 120, which are executed or interpreted by the conductor 120 to determine whether the particular object should be made visible. In one example, a particular object might have visibility rules 421 which provide that the user 133 is required to have completed a designated earlier object A before later object B is made visible. In one example, in a health context, a Scene object 230 asking the user 133 to commit to running five miles per day can be made not-visible until the user 133 has committed to, and successfully performed, running three miles per day at least three times per week. This has the effect that the visibility rules 421 provide the author 111 with a degree of control of the order in which objects are assembled and presented to the user 133 and their actions are performed by the user 133.
The eligibility rules 422 include descriptions of when the object is allowed to be performed by the user 133. The eligibility rules 422 are distinct from the visibility rules 421, at least in that any particular object can be made visible without being made eligible, that is, the user 133 can see that the particular object will be upcoming at some future point, but is not available at the moment. Similar to the visibility rules 421, in one embodiment, the descriptions for the eligibility rules 422 include instructions to the conductor 120, which are executed or interpreted by the conductor 120 to determine whether the particular object should be made eligible. In general, those objects which are made visible need not be made eligible.
In one example, a particular object might have eligibility rules 422 which provide that the user 133 is required to have completed a designated earlier object A before later object B is made eligible. This has the effect that the eligibility rules 422 also provide the author 111 with a degree of control of the order in which objects are assembled and presented to the user 133 and their actions are performed by the user 133.

In one embodiment, the exit rules 430 (for Act objects 210 and Stage objects 220) include an XP completion unlock 431, a set of exit actions 432, and a set of completion values 433.
The XP completion unlock 431 indicates a degree of completion the user 133 should attain before the Act object 210 or the Stage object 220 can be declared completed. In one example, the user 133 accumulates XP (from the gaming term “experience points”), which indicate a measure of how many activities the user 133 has completed, how advanced or how difficult those activities were, and possibly how valuable those activities were toward advancing the user's goals in the Journey 200. In one example, in a health context, the user 133 could accumulate five XP for each time they complete an early-morning exercise, such as running three miles. After the user 133 has accumulated enough XP, such as at least fifty XP, the XP completion unlock 431 allows the user 133 to complete the particular Act object 210 or the particular Stage object 220.
The exit actions 432 include a set of instructions to be executed by the conductor 120 upon exit from the Act object 410, Stage object 220, or Scene object 230. The exit actions 432 can include (A) a first set of exit actions to be executed by the conductor 120 if the user 133 decides to exit the object without completing it, or (B) a second set of instructions to be executed by the conductor 120 if the user completes the object, such as by finishing all activities associated with the object. The user might finish the activities associated with an Act object 210 or a Stage object 220 by accumulating sufficient XP to meet the stage XP completion unlock 431, or by completing a sufficient number of Scene objects 230 within a Stage object 220 (such as all of them, or some fixed number of them set by the author 111 in the Ractive), or by some other criterion selected by the author 111.
For Stage objects 220, the completion values 433 can include an XP value associated with the Stage object 220, such as for use with the Act object 210 enclosing the Stage object 220. Similarly, for Scene objects 230, the completion values 433 can include an XP value associated with the Scene object 230, such as for use with the Stage object 220 enclosing the Scene object 230. In one example, the Act object 210 enclosing the Stage object 220 is similarly completed, such as by accumulating sufficient XP to meet an associated act XP completion unlock, or by completing a sufficient number of Stage objects 220 within the Act object 210 (such as all of them), or by some other criterion selected by the author 111.

For Stage objects 220, the enclosed object lists 440 include (A) a first set of Scene objects 230 marked “visible”, with Scene objects 230 being marked visible similar to as described above with respect to visibility rules for the Stage object 220, (B) a second set of Scene objects 230 marked “entered”, with Scene objects 230 being marked entered to indicate that the user 133 has had at least some content presented thereto, and (C) a third set of Scene objects 230 marked “completed”, with Scene objects 230 being marked completed similar to as described above with respect to completion rules for the Stage object 220. Similarly, for Act objects 210, the enclosed object lists 440 include Stage objects 220 having similar properties.

In one embodiment, each Act object 210 includes a set of Stage objects 220. Similarly, each Stage object 220 includes a set of Scene objects 230. These Stage objects 220 can be assembled and presented to the user 133 as part of the user's interaction with the Act object 210, as specified by the author 111, and as determined by the conductor 120 controlling the performer 130, and in response to a set of object variables 450 for the Act object 210. Similarly, these Scene objects 210 can be assembled and presented to the user 133 as part of the user's interaction with the Stage object 220, as specified by the author 111, and as determined by the conductor 120 controlling the performer 130, and in response to a set of object variables 450 for the Stage object 220.

For Scene objects 230, the enclosed object lists 440 include components to be assembled and presented to the user 133 as part of presentation of the Scene 230. As also described above, components can include text, pictures (such as graphics, still pictures, animation, video, or otherwise), sound, and other modalities for presentation to the user 133. As also described above, those components 240 can be late-binded in response to object variables 450 associated with the Scene object 230.

In one example, Scene objects 230 can include components 240 which are responsive to the modality selected by the user 133. In one example, when the user 133 desires presentations to use sound rather than graphics, those components 240 which use the modality selected by the user 133 can be included in the Scene object 230 when presented by the performer 130.

In one example, Scene objects 230 can include components 240 which are responsive to the user's current physical user interface device 140. In a 1^{st} example, when the user 133 is using a mobile phone or other device with a relatively small screen, the conductor 120 can cause the performer 130 to present Scene objects 230 using those components 240 which are suitable for that mobile phone or relatively small screen. In a 2^{nd} example, when the user 133 is using a device with a relatively larger screen, the conductor 120 can cause the performer 130 to present Scene objects 230 using those components 240 which are suitable for that relatively larger screen.

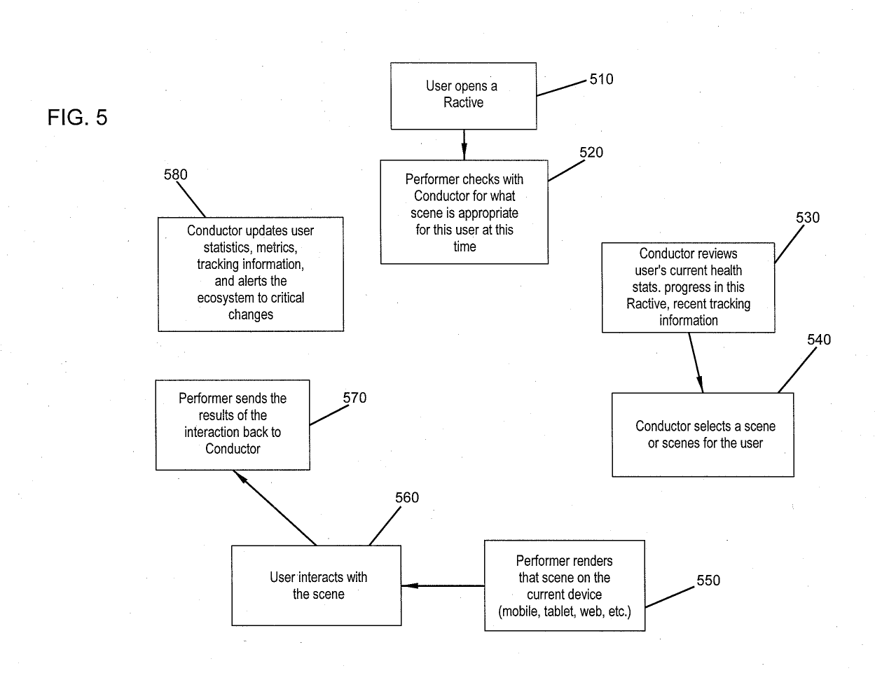

FIG. 5

FIG. 5 shows a conceptual drawing of an example presentation of a set of Scene objects.

In one embodiment, a presentation of a set of Scene objects 230 includes an interaction between the conductor 120 and the performer 130. The conductor 120 interacts with the Ractive, obtains information about the user 133, maintains the data structures 122 for the Ractive, and causes the performer 130 to present content elements to the user 133. The performer 130 interacts with the user 133, presents content elements to the user 133, and receives information from the user 133 and provides that information to the conductor 120.

At a step 510, a user 133 opens a Ractive. In this context, to “open” a Ractive includes the meaning of accessing the data structures included in the Ractive. As part of this step, the conductor 120 retrieves a copy of the Ractive, makes a new instance of the Ractive which is specific to that user 133, and initializes data structures 122 in the Ractive.

At a step 520, the performer 130 asks the conductor 120 to determine which Scene object 230 is appropriate to present to the user 133 at this time.

At a step 530, the conductor 120 reviews the data structures 122 in the particular instance of the Ractive relating to this particular user 133. The data structures 122 include the Ractive, information about this particular user 133, and the history of the user 133 with respect to this particular Journey 200. As described above, the conductor 120 examines each Scene object 230 to determine if it is eligible for presentation, and examines each eligible Scene object 230 to determine (and possibly re-compute) its priority.

At a step 540, the conductor 120 selects one or more Scene objects 230 for presentation to the user 133. As described above, the conductor 120 selects those one or more Scene objects 230 which have the highest priority. In those cases where the conductor 120 selects a single Scene object 230, the performer 130 will (at the next step) present that single Scene object 230 to the user 133. In those cases where the connector 120 selects more than one Scene 230, the performer 130 will (at the next step) present a choice of Scene objects 232 the user 133, for the user 133 to select among.

At a step 550, the performer 130 receives from the conductor 120 the selected one or more Scene objects 230 for presentation to the user 133. In those cases where the selected Scene object 230 includes only a single Scene object 230, the performer 130 simply presents that Scene object 230 two the user 133. In those cases where the Scene object 230 includes more than one Scene object 230, the performer 130 presents the user 133 with an opportunity to choose from among those more than one Scene objects 230, and in response thereto, presents to the user 133 the single Scene object 230 selected by the user 133.

In one embodiment, the performer 130 determines the current device with which the user 130 is interacting with the performer 130, and tailors the Scene object 230 in response to that current device. In one example, if the current device includes a small-screen mobile device, such as a cellular telephone, the performer 130 chooses for presentation a variation of the selected Scene object 230 which matches a size of that small screen mobile device. In another example, the performer 130 chooses for presentation of variation of the selected Scene object 230 a size (and possibly other capabilities) of the current device, so that if the current device has a relatively larger screen, the performer 130 can include larger or more elements for presentation to the user 133, while if the current device has relatively smaller screen, the performer 133 can include smaller or fewer elements for presentation to the user 133.

At a step 560, the user 133 interacts with the performer 130, with the effect of interacting with the Scene object 230. The performer 130 collects any feedback from the user 133, including both choices, data, and information presented by the user 133 to the performer 130, as well as possibly timing information (with respect to how long it takes the user 133 to respond) as well as modality information (with respect to whether the user 133 presents their information using a keyboard, pointing device, or other form of input).

At a step 570, the performer 130 packages (into a set of results of the interaction) information and other results from the just earlier step, and sends those results of the interaction to the conductor 120.

At a step 580, the conductor 120 updates data structures 122 in the Ractive, including such information as user statistics, metrics, and tracking information. As part of this step, the conductor 120 determines if there are any Scene objects 230 which are waiting for any of those updates. If any Scene objects 230 are waiting for any of those updates, the conductor 120 examines those Scene objects 230, determines if any of those Scene objects 230 require actions in response to those changes, and if so, performs those actions.

The method continues with the step 520, until such time as any Scene object 230 indicates that the Ractive has arrived at a completion point and the Journey 200 is over.

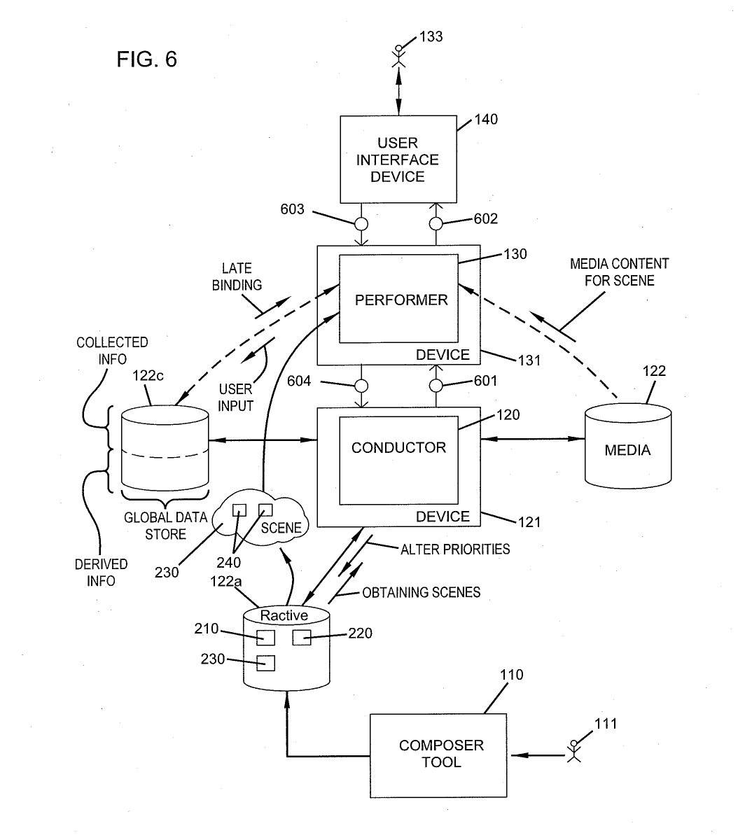

FIG. 6

FIG. 6 shows a conceptual drawing of an example method of selecting and presenting Scene objects.

As described above, the system 100 includes a conductor 120, executed on one or more computing devices 121 and using one or more data structures 122. In one embodiment, the data structures 122 include a Ractive 122a, a set of media storage 122b, and a global data store 122c. As also described above, the Ractive 122a includes a set of pointers to digital content in the media storage 122b, a set of Act objects 210, a set of Stage objects 220, and a set of Scene objects 230. As also described above, the global data store 122c includes information regarding the particular user 133 interacting with the system 100, including at least (A) collected information, that is, information which has been collected from the user 133 in response to questions asked of the user 133 by the system 100, and (B) derived information, that is, information which has been received from sources other than the user 133, such as sensors coupled to the system, or such as medical records or insurance records.

In one embodiment, the conductor 120 is responsive to the Ractive 122a and the global data store 122c to select content for assembly and presentation to the user 133, such as a set of next Scene objects 230 for assembly and presentation to the user 133. As described herein, the Ractive 122a includes a set of rules for selecting Scene objects 230; these rules are also responsive to the Ractive 122a itself (in particular, its rules for modifying rules) and the global data store 122c, for possible modification. In general, the conductor 120 attempts to select a set of next Scene objects 230 which are optimal for the user 133 in the conduct of their Journey 200.
For example, the conductor 120 is responsive to the Ractive 122a and the global data store 122c to select a picker Scene object 230, having the property of allowing the user 133 to select a next Scene object 230. In one embodiment, the conductor 120 determines a priority value for each Scene object 230 allowed to be presented at that time, and selects (according to a rule in the Ractive 122a) a predetermined number of those Scene objects 230 having the most superior priority values for the picker Scene object 230. When the user 133 chooses one of the assembled and presented choices, the Journey 200 is further personalized to that user 133. In one embodiment, the conductor 120 maintains a record of which ones of the Scene objects 230 the user 133 selected from the picker Scene object 230.
For example, the conductor 120 is responsive to the global data store 122c to determine a set of statistical information representative of which Scene objects 230 are most likely to be actually selected by users 133 from picker Scene objects 230, and when selected, which Scene objects 230 are most likely to be successfully carried through by users 133 (as reported to the conductor 120 as either collected data or derived data). In response to that set of statistical information, the conductor 120 modifies the priorities associated with individual Scene objects 230 for all users, with the effect that Scene objects 230 assembled and presented to users 133 at later times are responsive to that set of statistical information. In one embodiment, use by the conductor 120 of that set of statistical information is responsive to rules created by the authors 111 of the Ractive 122a.
In one such case, the conductor 120 maintains, in the global data store 122c, a measure of user feedback for each Scene object 230, including information responsive to one or more of the following:
   Whether the Scene object 230 was entered, and if so, by how many users 133 and by what type of users 133.
   Whether the Scene object 230 was completed, or how the Scene object 230 was otherwise exited, and if so, by how many users 133 and by what type of users 133.
   A set of ratings for that Scene object 230 collected from those users 133, and one or more aggregations of those ratings in response to what type of users 133 provided those ratings. For a 1^{st} example, those ratings might include a measure of likeability provided by those users 133 and a measure of success provided in response to actions by those users 133. For a 2^{nd} example, those ratings might be aggregated separately with respect to those users' personal attributes, geographic location, organizational affiliation, and other factors.
   This has the effect that the conductor 120 can attempt to maximize user engagement with the content, by providing a prediction of which Scene objects 230 are most likely to be well received by users 133 (in response to those user's collected and derived information), and which Scene objects 230 are most likely, when those Scene objects 230 challenge users 133 to perform one or more tasks, are most likely for those tasks to be successfully achieved by those users 133. For example, a Scene object 230 which challenges users 133 to walk for five minutes might be more likely to be successful than a Scene object 230 which challenges users 133 to run for thirty minutes, particularly for otherwise sedentary users 133.
   The measure of feedback from users 133 maintained in the global data store 122c can be thought of as a form of crowd-sourcing of information relating to the desirability and success rate for each Scene object 230. For example, the desirability and success rate of a particular Scene object 230 might be relatively superior for users 133 with a history of regular physical activity, but might be relatively less so for users 133 without such history.
For example, the conductor 120 might use information with respect to the user's specific attributes, including without limitation one or more of: age, attitude, beliefs, gender, health history, location, and preferences. The conductor 120 might examine the global data store 122c and determine that the user 133 is female, not currently active physically, enjoys doing outdoors activities with others, but has a low level of confidence in her ability to begin exercising on her own. In this example, the conductor 120 would, responsive to that statistical information maintained in the global data store 122c, would assemble and present content to that user 133 designed to build her confidence by completing small steps toward initiating an outdoor walking program with a friend or colleague. In contrast, the conductor 120 would, responsive to that statistical information refrain from assembling and presenting content to that user 133 about indoor weight lifting.
For example, the conductor 120 might use information with respect to the user's specific current weather and local resources. The conductor 120 might examine the global data store 122c and determine that the user 133 is visiting Palo Alto, where the weather might then be a sunny and mild day. In this example, the conductor 120 might assemble and present content to the user 133 recommending a short walk to a specific destination at Stanford University, selected based on the user's interests and attributes, as well as a map to get there. In contrast, if the user 133 is visiting Minneapolis, where the weather might then be a wet and bitter day, the conductor 120 might assemble and present content to the user 133 recommending an indoor route to the Mall of America, along with a walking route to an exhibit there, projected to be of highest interest to the user 133 based on the user's other attributes. If the user 133 is also participating in a nutritionfocused Journey, the conductor 120 might assemble and present content to the user 133 recommending particular nearby restaurants and markets with healthy food choices.
For example, the conductor 120 might use information with respect to the user's past choices or feedback (whether collected information or derived information). The conductor 120 might examine the global data store 122c and determine that the user 133 has consistently provided relatively low ratings to content in video format. In this example, the conductor 120 reduces the priority of content in video format, with the effect that content in video format becomes less likely to be assembled and presented to the user 133. In contrast, if the user 133 has has consistently provided relatively high ratings to so-called “social” content, that is, content involving completing tasks with others, the conductor 120 increases the priority of content in social format, with the effect that content in social format becomes more likely to be assembled and presented to the user 133.
For example, the conductor 120 might use statistical information collected by interaction with more than one user 133 to determine a likelihood of user preference. The conductor 120 might examine the global data store 122c and determine that women between ages 45 and 54 achieve better results when served content that involves working with others, while men in the same age group achieve better results working on their own. In this example, the conductor 120 would adjust the priority of content to be assembled and presented to the user 133 in response to whether the user 133 was in the first such group or the second such group.
For example, the conductor 120 might use statistical information collected by interaction with more than one user 133 to determine a likelihood of user success. The conductor 120 might examine the global data store 122c and determine that a particular user 133 is more likely to quit smoking “cold turkey” than to quit smoking by weaning the user 133 away from tobacco use. In this example, the conductor 120 would adjust the priority of content to be assembled and presented to this particular user 133 in response thereto, with the effect of assembling and presenting content to this particular user 133 that is more probable of success at eliminating tobacco use.

As described above, the system 100 includes a performer 130, executed on one or more computing devices 131 (in one embodiment, distinct from the computing devices 121 on which the conductor 120 is executed). The performer 130 is coupled to the conductor 120, and receives, from time to time, information 601 with respect to a decision of which Scene object 230 to next present.

In one embodiment, the conductor 120 obtains a pointer to the selected content in the media storage 122b, and presents that pointer to the performer 130 with the information 601. In alternative embodiments, the conductor 120 includes the selected content from the media storage 122b and presents that selected content directly to the performer 130 with the information 601. This has the effect that, in such alternative embodiments, the performer 130 can have a direct connection to the media storage 122b.

Similarly, in one embodiment, when the selected content included late-binded information, such as a BMI for the user 133 to be assembled and presented in-line with the selected content, the conductor 120 obtains a pointer to the late-binded information, and presents that pointer to the performer 130 with the information 601. In alternative embodiments, the conductor 120 includes the late-binded information from the global data store 122c, and presents that late-binded information directly to the performer 130 with the information 601. This has the effect that, in such alternative embodiments, the performer 130 can have a direct connection to the global data store 122c.

The performer 130 serves the Scene object 230 to the user 133. To perform this action, the performer 130 performs the following steps:
The performer 130 identifies the content components associated with the Scene object 230 selected by the conductor 120.
The performer 130 identifies a physical user interface device 140 associated with the user 133 and being used to interact with the user 133.
The performer 130 adjusts the Scene object 230 to the modality associated with that particular physical user interface device 140. In one embodiment, if the modality associated with that particular physical user interface device 140 indicates that particular content components are associated with that particular physical user interface device 140, the performer 130 selects those particular content components. For example, the performer 130 can select a smaller or lower-resolution picture if that is necessary or desirable to fit on a small-screen mobile device.
The performer 130 late-binds the late-binded information to the Scene object 230 selected by the conductor 120. In one example, if the late-binded information includes a BMI for the user 133, the performer 130 obtains that value, either from the global data store 122c or from the information 601. In this example, the late-binded information can be included in the content for the Scene object 230, such as in a message like “Your BMI is . . . ”, where the user's BMI is inserted into the blank space.
The performer 130 sends information 602 with respect to the Scene object 230, including its content components, to the physical user interface device 140 associated with the user 133.

When the performer 130 serves the Scene object 230 to the user 133, the user 133 has the opportunity to respond to the Scene object 230. In one embodiment, the user 133 can respond to the Scene object 230 with a choice of a next Scene object 230 that the user 133 desires for presentation, or with information requested by the Scene object 230. Accordingly, once the performer 130 serves the Scene object 232 the user 133, the performer 130 might have information 603 to collect with respect to the Scene object 230.

The performer 130 receives any information 603 with respect to the Scene object 230, including any choices or collected information from the user 133, from the physical user interface device 140 associated with the user 133. The performer 130 packages that information 603 into one or more messages 604, and sends those one or more messages 604 to the conductor 120. This has the effect that the conductor 120 can take into account any feedback from the user 133 when determining a next Scene object 230 for causing the performer 130 to present to the user 133.

The conductor 120 receives the one or more messages 604, indicating from the performer 130 that the Scene object 230 has been served to the user 133. The conductor 120 determines a next Scene object 230 to be presented to the user 133 by the performer 130. To perform this action, the conductor 120 performs the following steps:
The conductor 120 records any new information regarding user 133 in the global data store 122c. If that new information was received from the user 133, the conductor 120 maintains that information as “collected” information, as described above. If that new information was received from a source external to the user 133, the conductor 120 maintains that information as “derived” information, as described above.
In one embodiment, the conductor 120 is coupled directly to sources external to the user 133, and receives all derived information directly, rather than that information being received from the performer 130. However, in the context of the invention, there is no particular requirement for any such limitation. Example, the performer 130 may be coupled to sources external to the user 133, may receive derived information from those sources, and may send that derived information on to the conductor 120.
In one embodiment, derived information can include a measure of trust associated with collected information that was received from the user 133. In a first example, if the user 133 (such as a user 133 working on weight loss) reports weight values that are inconsistent with those reported from an external source (such as a weight scale independently coupled to the system 100 and reporting to the conductor 120), that measure of trust associated with the user 133 can be set by the conductor 120 to indicate that weight values reported by the user 133 are not as trustworthy as otherwise desirable. In contrast, in a second example, if the user 133 (such as a user 133 working on diabetes management) reports blood glucose measurements which are reliably consistent with those reported from an external source (such as a medical report independently reported to the conductor 120), that measure of trust associated with the user 133 can be set by the conductor 120 to indicate that blood glucose values reported by the user 133 are sufficiently trustworthy. In one embodiment, a distinct measure of trust can be associated with each value maintained in the user's global data store 122c.
In one embodiment, the global data store 122c can also maintain, according to the Ractive, for one or more data values, a callback notification to inform the conductor 120 when that data value changes (or when that data value changes by an amount described by the Ractive as large enough to be significant). In such cases, when the data value changes, and when a callback notification has been set by the Ractive, the conductor 120 receives a message from the global data store 122c to so indicate. The conductor 120 can act in response to that message by taking such actions as (A) altering other data values in the global data store 122c, (B) altering priority values for Scene objects 230, or (C) taking some other action.
The conductor 120 performs any exit instructions associated with the Scene object 230, such as similar to the stage exit actions 432, as described above. In one example, exit instructions associated with the Scene object 230 can include modifying XP associated with the user 133 for the Stage object 220 enclosing that particular Scene object 230. Accordingly, where that Stage object 220 enclosing that particular Scene object 230 requires a selected XP total for completion, any XP earned by the user 133 for completing the Scene object 230 can be added to that total.

The conductor 120 reevaluates the priority associated with each Scene object 230 in the enclosing Stage object 220, in response to information with respect to the user 133, including any information gleaned from the user's completion (or the user's exit without completion) of the Scene object 230 by the user 133. As part of this step, the conductor 120 modifies the priority value associated with each Scene object 230.

The conductor 120 chooses the one or more Scene objects 230 with the highest associated priority.
The author 111 can follow the most recent Scene object 230 with a picker Scene object 230. In a picker Scene object 230, the user 133 is presented with a choice of multiple Scene objects 230, and is allowed to choose one of those multiple Scene objects 230 as the next Scene object 230 for presentation. In such cases, the author 111 indicates, in the Ractive, how many Scene object 230 the user will be allowed to choose from, and the conductor 120 chooses that many Scene objects 230 for presentation to the user 133 as part of the picker Scene object 230.
Alternatively, the author 111 can follow the most recent Scene object 230 with a designated single Scene object 230 which must follow the most recent Scene object 230. In such cases, the author 111 indicates, in the Ractive, that the most recent Scene object 230 must be followed by a designated next Scene object 230, and the conductor 120 chooses that one Scene object 230 for presentation to the user 133 as the next Scene object 230. When the author 111 indicates, in the Ractive, that a particular Scene object 230 must be followed with a particular next Scene object 230, those Scene objects 230 are sometimes referred to herein as a “sequence”.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magnetooptical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. A method, including steps of
presenting a sequence of content elements from a non-transitory memory maintaining said content elements, each said content element being associated with a weighting value and including a sequence of computer-readable encoding elements interpretable by a processor, said steps of presenting including steps of:
determining a plurality of weighting values, one for each of a plurality of said content elements;
in response to said plurality of weighing values, selecting one or more content elements to present;
presenting said selected content elements;
receiving information in response to one or more users;
adjusting one or more weighting values in response to said information; and
repeating said steps of presenting a sequence of content elements, until a selected termination event.

2. A method as in claim 1, including steps of
late-binding one or more values to include in said content elements in response to one or more values determined with respect to a particular user;
said steps of late-binding being performed after said steps of selecting one or more content elements to present; and
said steps of late-binding being performed before said steps of presenting said content elements.

3. A method as in claim 1, wherein
said steps of determining a plurality of weighting values include steps of
selecting each said weighting value dynamically in response to a history of actions taken by one or more users in response to said content elements.

4. A method as in claim 1, wherein
said steps of determining a plurality of weighting values include steps of
selecting each said weighting value dynamically in response to a history of actions taken by one or more users in response to said content elements.

5. A method as in claim 1, wherein
said steps of presenting said selected content elements including steps of
determining a modality of a user interface associated with a user to which said selected content elements are to be presented; and
adjusting at least one of: a component to include in said selected content elements, a format of said selected content elements.

6. Apparatus including
a plurality of scene objects, each said scene object having non-transitory memory maintaining entry instructions, a weighting value, a content element, and exit instructions;
said entry instructions including computer-readable instructions interpretable by a processor to determine a priority of said scene object in response to said weighting value;
said content element including a sequence of computer-readable elements interpretable by a processor to encode human-sensible content;
said exit instructions including computer-readable instructions interpretable by a processor to adjust said weighting value in response to information received in response to one or more users.

7. A non-transitory medium including computer-readable instructions interpretable by a processor to perform steps of
presenting a sequence of content elements from a non-transitory memory maintaining said content elements, each said content element being associated with a weighting value and including a sequence of computer-readable encoding elements interpretable by a processor, said steps of presenting including steps of:
determining a plurality of weighting values, one for each of a plurality of said content elements;
in response to said plurality of weighing values, selecting one or more content elements to present;
presenting said selected content elements;
receiving information in response to one or more users;
adjusting one or more weighting values in response to said information; and
repeating said steps of presenting a sequence of content elements, until a selected termination event.

8. A non-transitory medium as in claim 7, including steps of
late-binding one or more values to include in said content elements in response to one or more values determined with respect to a particular user;
said steps of late-binding being performed after said steps of selecting one or more content elements to present; and
said steps of late-binding being performed before said steps of presenting said content elements.

9. A non-transitory medium as in claim 7, wherein
said steps of determining a plurality of weighting values include steps of
selecting each said weighting value dynamically in response to a history of actions taken by one or more users in response to said content elements.

10. A non-transitory medium as in claim 7, wherein
said steps of determining a plurality of weighting values include steps of
selecting each said weighting value dynamically in response to a history of actions taken by one or more users in response to said content elements.

11. A non-transitory medium as in claim 7, wherein
said steps of presenting said selected content elements including steps of
determining a modality of a user interface associated with a user to which said selected content elements are to be presented; and
adjusting at least one of: a component to include in said selected content elements, a format of said selected content elements.
